(19) United States
(12) Patent Application Publication
(10) Pub. No.: US 2005/0252102 A1
(43) Pub. Date: Nov. 17, 2005

(54) Window well liner

(76) Inventor: Bryan M. Buchi, West Jordan, UT (US)

Correspondence Address: Starkweather & Associates, 9035 S 1300 E, Suite 200, Sandy, UT, 84094, US

(21) Appl. No.: 10/826,990

(22) Filed: Apr. 19, 2004

(51) Int. Cl. E06B 5/02

(52) U.S. Cl. 52/107

(57) ABSTRACT

A liner with a three dimensional pattern configured to secure to a window well. A mold is coated with a urethane release formula. Design colors are sprayed onto a pattern of the mold to reflect a natural rock appearance. Polyurethane is sprayed over the colors and onto the mold according to well known molding techniques and allowed to cure. The liner is removed and touched up for imperfections and coated with an ultraviolet coating to improve weatherability. A window well is measured and the liner is cut to match the window well dimensions. Screws fasten the liner to the window well. The screw heads are caulked and painted to match the appearance of the liner. A top cap may be applied to a top edge of the window well and liner.

### BACKGROUND OF THE INVENTION

1. Field of the Invention

This invention relates in general to window well liners. Specifically, the present invention relates to a liner secured to a window well.

2. Description of the Related Art

Nearly every home with a basement has at least one window well. The window well is formed of a large piece of corrugated metal or concrete which forms a cavity around a window to allow the window to open, and to allow people to climb in and out of the basement through the window.

Unfortunately, the window wells are unsightly. Generally, because they are underground, they tend to grow weeds, insects thrive in them, and they are very difficult to clean. The view from a basement window into the window well is uninviting. Many home owners prefer to avoid window wells for these reasons, but many times window wells are unavoidable.

Some home owners have spent thousands of dollars, or more, landscaping their yards to hide the unsightly window wells or to have the land graded to remove the need for the window wells. Rocks, or stones, have emerged as a popular way of improving the appearance of one's home or property and have been used in landscaping for aesthetic purposes for years. Rocks are used to form birdbaths, hollow rock planters of various sizes, artificial waterfalls, decorative fences, walls, and rock gardens. The use of rocks for aesthetic purposes is very popular.

Although rocks are very popular, there are numerous disadvantages to using rocks. Specifically, natural rocks are heavy, of random sizes and shapes, and may have to be transported to great distances from their natural source of origin to the place of intended use. Transportation costs can often exceed the labor costs of quarrying the rock and handling it in the final placement on the landscaped grounds.

Another problem with natural rocks, particularly large ones, is that they are not easily handled. Usually there are no natural handholds or attachment points for lifting and placing them, and as a result, large, heavy rocks must be handled with hoists equipped with slings or using earth moving equipment. This is difficult, sometimes dangerous, and always time consuming.

Additionally, it is often difficult to use natural rock incorporated into dimensional structures, such as fencing, lamp posts, barbecue holders, and even furniture, such as rock tables and benches. In order to use the natural rock in these circumstances, it is often necessary to employ the skills and equipment of a stone cutter.

A further problem with natural rocks is that they do not generally serve as an adequate form of foundation for structures. Homes must be built on foundation material that is sure to pass certain rules and regulations. Rocks gathered from distant quarries lack the kind of quality control to provide sufficient confidence that the rocks will maintain structural integrity under heavy loads. Accordingly, it is often necessary to use a tried-and-true material, such as cement, for the foundation, even though cement may not be as aesthetically pleasing.

Still another problem with natural rocks is the cost associated with hiring professionals to build rock structures for design purposes, or to make a home, or the like, more aesthetically attractive. Many people prefer the appearance of rock structures over the appearance of cement or metal, however, many cannot afford that extra expense or upgrade, especially at the time a new home is being built.

Accordingly, what is needed is an artificial rock liner which simulates the appearance, texture, durability, and aesthetic integrity of a natural rock wall, which can be formed in a mold for any desired purpose, and attached to an underlying structure, such as a window well.

### SUMMARY OF THE INVENTION

The present invention has been developed in response to the present state of the art, and in particular, in response to the problems and needs in the art that have not yet been fully solved by currently available window well liners. Accordingly, the present invention has been developed to provide an artificial rock liner for window wells designed to exhibit natural rock characteristics and to maintain original color, shape, and form.

More specifically, the present invention provides a decorative liner configured to fasten to a window well to beautify the underlying structure. A mold is coated with a urethane release formula. Design colors are sprayed onto a pattern of the mold to reflect a natural rock appearance. Polyurethane is sprayed over the colors and onto the mold and cured according to well known mold procedures. The liner is removed and touched up for imperfections and coated with an ultraviolet coating to protect against fading. A window well is measured and the liner is cut to match the window well dimensions. Screws fasten the liner to the window well. The screw heads are caulked and painted to match the appearance of the liner. A top cap may be applied to a top edge of the window well and liner.

Accordingly, there are several features and advantages of the present invention. One feature and advantage of the present invention creates an artificial rock liner, which simulates the appearance and texture of a desired natural rock wall, which can be formed in a mold for any shape and design. Another feature and advantage of the present invention is a method by which the artificial rock platform can be secured to a window well.

Another feature and advantage of the present invention provides for artificial rock platforms that may be attached to a window well at any time, even years after the structures were built.

Another feature and advantage of the invention provides an artificial rock platform with long lasting aesthetic characteristics, such that the colors maintain their original appearance, and enduring physical characteristics, such that the artificial rock platform maintains the original strength, toughness, and integrity.

Yet another feature and advantage of the invention eliminates the concerns associated with having a potentially dangerous rock structure where a rock may come loose and cause serious bodily injury. Another feature and advantage of the invention provides an artificial rock platform that may be easily applied to a structure without the need for specialized skills acquired through years of practice and labor. Another feature and advantage of the invention eliminates the need to transport large and heavy rocks great distances. Another feature and advantage of the present invention removes the unsightly appearance of window wells.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates typical window well liners including general patterns according to one embodiment of the present invention;

FIG. 2 illustrates a top view of one embodiment of a window well configured to receive a liner;

FIG. 3 illustrates a cross-sectional side view of a window well attached to a foundation of a home according to one embodiment of the present invention;

FIG. 4 illustrates a view of a window well with a liner attached from inside a home according to one embodiment of the present invention; and

FIG. 5 illustrates a top view of a window well with a liner.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

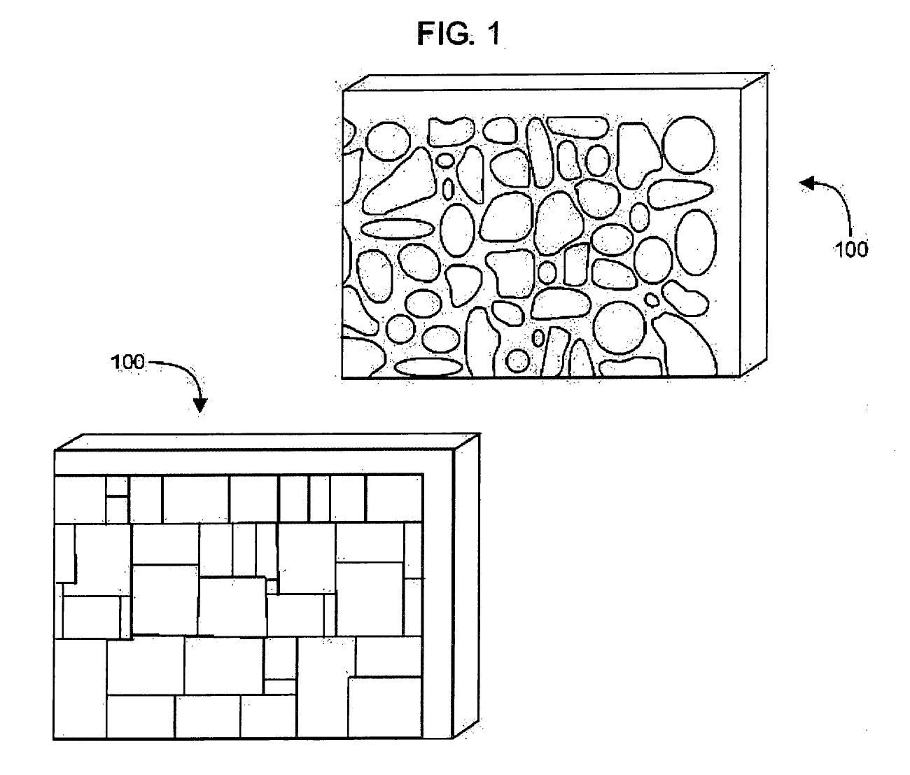

FIG. 1 illustrates embodiments of typical liners 100 including liner patterns according to the present invention. The liner 100 is generally flat and may include a pattern of artificial rocks on one side designed to reflect a rock wall or rock structure. The pattern, such as round shaped rocks, square rocks, rectangular rocks, river rocks, granite, slate, brick, wood paneling, stucco, etc., may be designed to reflect any type of surface.

The liner 100 may be comprised of any type of material, including plastic, rubber, wood, ceramic, etc. In this embodiment, the liner 100 is polyurethane and formed on a mold according to well known mold techniques. Generally, the mold is coated with a urethane release, such as BSP FV 1622, which can be purchased at most commercial mold and paint facilities. Preferably, before spraying the mold with polyurethane, the mold is painted with alkyd based paint so that when the liner 100 is removed from the mold, no significant painting is required. The alkyd based paint chemically reacts with the polyurethane during the curing period of the liner to improve weatherability of the colors. The type of pattern determines the color and design of the paint applied to the mold. A skilled artisan will recognize that particular colors are generally used for particular patterns. For instance, a skilled artisan will recognize that to give the liner 100 a brick appearance, the mold may be painted red with gray lines to give the cement look between the bricks. To give the liner 100 a granite appearance the mold may be painted gray. Similarly, a skilled artisan will recognize that multiple colors, shades, and hues may be used to give each rock a natural look and to match the three-dimensional appearance of the liner 100.

In a preferred embodiment, after the mold has been painted to provide a natural look, the mold is sprayed with a combination of HYS DX HT-2090F A and HYS DX HT-2090F B natural polyurethane. These polyurethane products may be purchased at most local dealers. The mold is sprayed with sufficient polyurethane to give the liner 100 enough structural integrity to prevent significant sagging when the liner 100 is secured to a window well. In this embodiment, the liner 100 is between approximately ⅜ths to ½ inch thick at the edges of the liner 100. In another embodiment the liner 100 may be thicker or thinner. In another embodiment, rigid members, screen mesh, or mounting plates are integrated into the liner 100 to add stiffness to the liner 100 and improve mounting strength.

After the liner 100 has cured in the mold according to well known techniques, the liner 100 is peeled from the mold and any imperfections are repaired. For instance, it is possible that the paint did not react completely with the polyurethane and the colors may need touch-up. A polyurethane ultraviolet layer is applied to eliminate paint fading and improve weatherability. The polyurethane ultraviolet layer materials may be purchased at most local dealers.

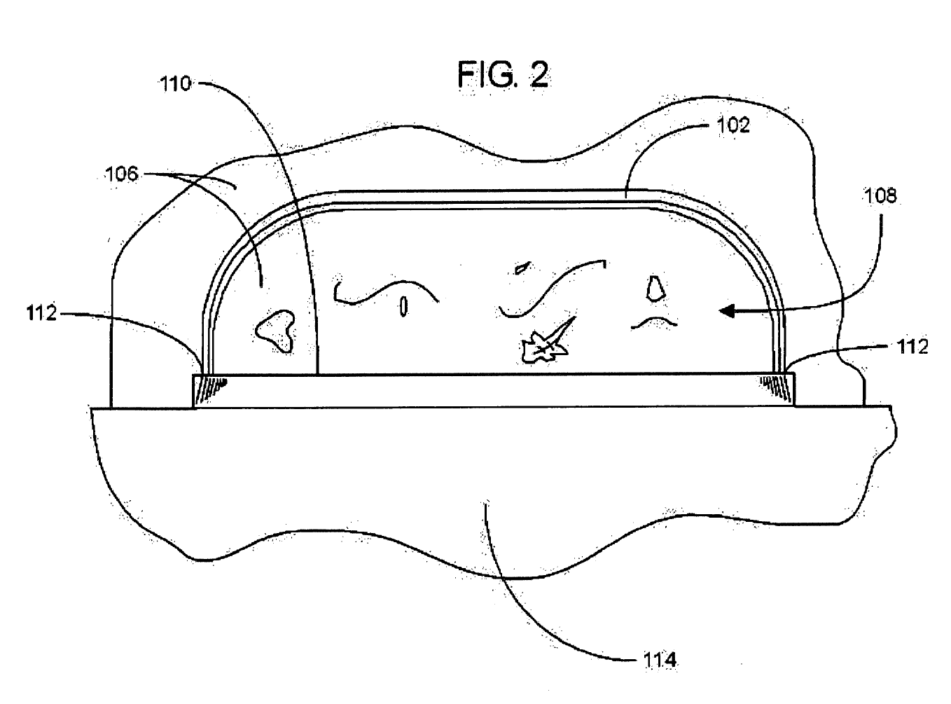

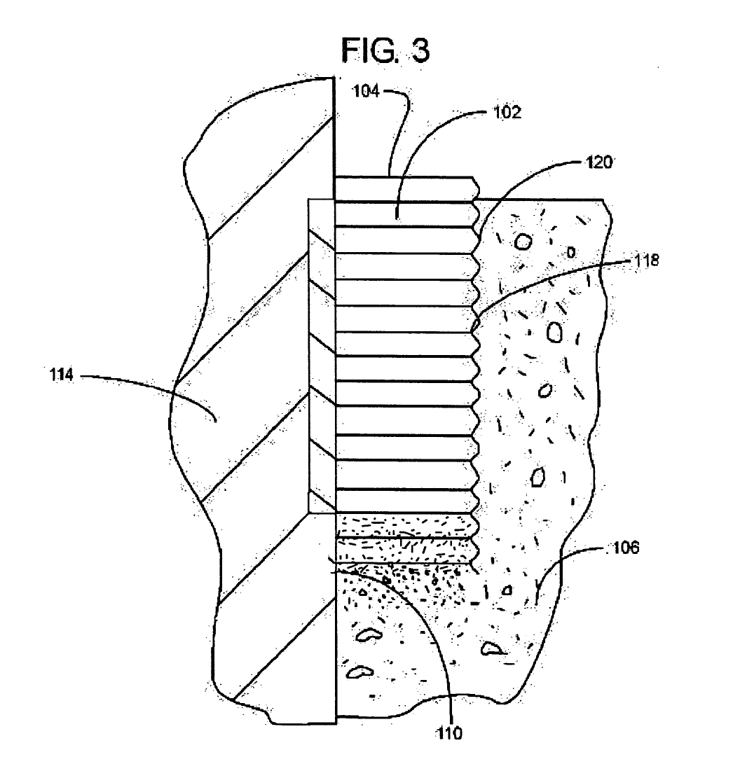

FIGS. 2 and 3 illustrate a top view and a side cross-sectional view of a typical window well 102, respectively. After the liner 100 has been removed from the mold and touched-up, measure the dimensions of the window well 102 determined to receive the liner 100. First, measure the height of the window well 102. The height, in this embodiment, is the distance from the top 104 of the window well 102 to approximately three inches below ground 106 in a cavity 108 between the window well 102 and a window 110. Generally, the ends 112 of the window well 102, where the window well 102 attaches to a foundation 114, should be equal in height. However, in certain circumstances the window well 102 may not be installed perfectly level. Accordingly, it is recommended to measure the height of each end 112 of the window well 102 where the window well 102 attaches to the foundation 114. Second, measure the length of the window well 102. The length of the window well 102 is the window well's 102 perimeter.

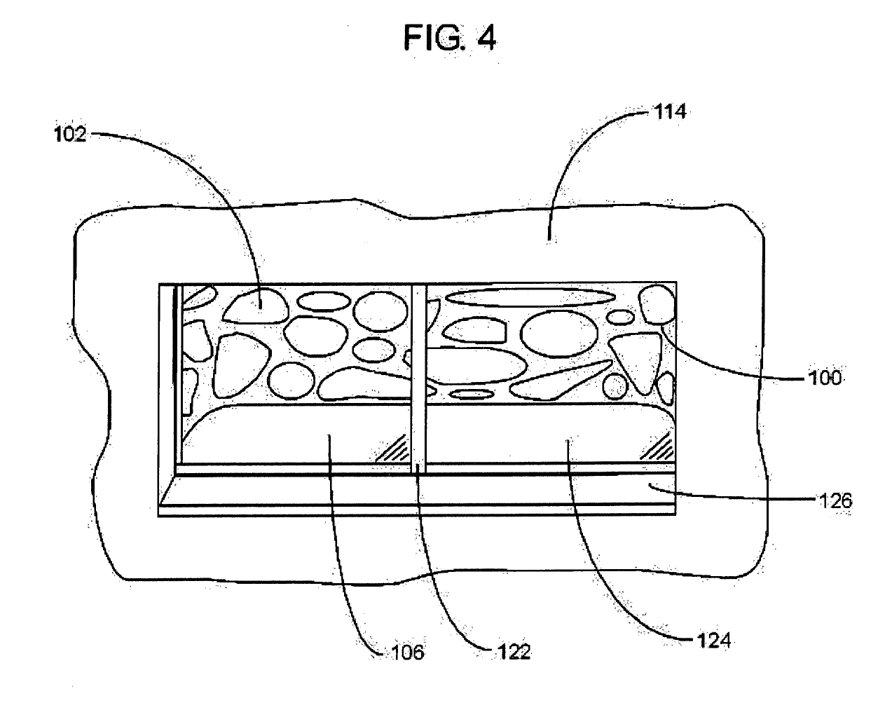

Mark the dimensions on the liner 100. For applications involving securing the liner 100 (See FIG. 4) to the inside of the window well 102 the liner 100 should be cut shorter than the measured perimeter of the window well 102. For example, for liners 100 with patterns exhibiting protrusions more than approximately two inches, i.e. river rock patterns with large round rock protrusions, the liner 100 should be cut approximately three inches shorter than the measured perimeter of the window well 102. For liners 100 with patterns exhibiting protrusions between approximately one to two inches, i.e. rocks with small protrusions, the liner 100 should be cut approximately one to two inches shorter than the measured perimeter of the window well 102. For liners 100 with patterns exhibiting protrusions less than one inch, i.e., flat, square rocks with little or no protrusions, the liner 100 should be cut approximately one inch shorter than the perimeter of the window well 102.

Cut the liner 100 according to the measured dimensions, subject to the limitations described above. The liner 100 may be cut with any type of saw capable of cutting polyurethane.

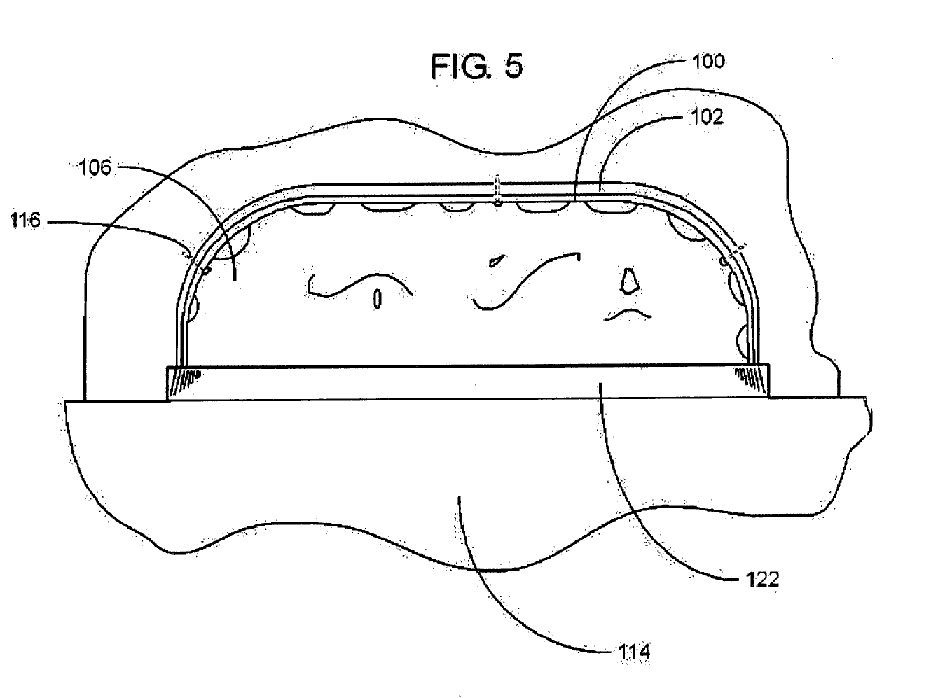

FIGS. 4 and 5 illustrate one embodiment of the liner 100 attached to a window well 102. Specifically, FIG. 4 illustrates the liner 100 viewed through a window frame 122, window sill 126, and window glass 124 and FIG. 5 illustrates a top view of the liner 100 secured to the window well 102. To attach the liner 100 to the window well 102, remove rocks and dirt around the bottom perimeter of the window well 102 approximately three inches deep into the ground 106. Place the liner 100 inside the window well 102 and position the ends of the liner 100 at the ends 112 of the window well 102 where the window well 102 engages the foundation 114 of the home. Press the liner 100 against the window well 102. Using self-tapping screws 116, starting from the right edge of the liner 100, place three to four screws 116 into proud sections 118 (See FIG. 3) of the window well 102, rather than into indented grooves 120 (See FIG. 3), along the right edge. Where the window well 120 starts to bend, place another two to three screws 116 through the liner 100 into the proud sections 118 of the window well 102. Place another two to three screws 116 in the middle of the liner 100 into the proud sections 118 of the window well 102. Place another two to three screws 116 where the window well 102 bends on the left side and place three to four screws 116 on the far left side where the left side of the window well 102 engages the foundation 104 of the home. Again, place the screws 116 into the proud sections 118 of the window well 102 rather than into the indented groove 120. It is noted that additional screws 118 may be used if preferred, or if necessary, depending on the height and perimeter of the window well 120.

Using a cutting tool, cut the top edge of the liner 100 to match the top 104 of the window well 1O2. Caulk and paint all screw 116 heads to match the painted portions of the liner 100. Replace dirt and rocks back against the liner 100. Place a top cap (not shown) over the top of the liner 100 and the top of the window well 102. In a preferred embodiment, the top cap is glued to the liner 100 and the window well 102, however, any securing means may be used. The top cap may be a piece of flexible tubing cut lengthwise to receive the top edge ofthe liner 100 and the top edge 104 ofthe window well 102. Caulk may be applied to the edges of the liner 100 where the liner 100 meets the foundation 114.

It is understood that the above-described arrangements are only illustrative of the application of the principles of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification discusses the use of screws 116 to fasten the liner 100 to the window well 120, it is envisioned that any type of securing means, or any combination of securing means, may be used, such as glue, spikes, clamps, clasps, etc.

Additionally, although the specification discusses the use of patterns giving the appearance of natural rock, it is envisioned that any type of pattern, characters, shapes, and forms may be used, such as ornamental designs, geometric patterns, cartoon characters, animals, cars, trucks, airplanes, scenery, animals, words, letters, numbers, etc.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A liner for lining window well, comprising:
a first side with a three-dimensional pattern protruding therefrom;
a second side configured to contact a window well; and
wherein the window well liner is configured to attach to the window well.

2. The window well liner according to claim 1, wherein the first side comprises a pattern of artificial rocks designed to give an appearance of a rock wall.

3. The window well liner according to claim 1, wherein the window well liner is comprised of polyurethane.

4. The window well liner according to claim 1, wherein the window well liner further comprises a cap secured to a top surface of the liner, and configured to cover a top surface of a window well and the top surface of the liner.

5. The window well according to claim 1, wherein the window well liner is secured to the window well with screws.

6. The window well according to claim 5, wherein the screws pass through the liner and into a proud section of the window well.

7. A window well, comprising:
a window well liner secured to an inside surface of the window well, and having a three dimensional pattern; and
a cap engaging a top edge of the window well liner and a top edge of the window well.

8. The window well according to claim 7, wherein the window well liner is comprised of polyurethane.

9. The window well according to claim 7, wherein the pattern is a series of round and elliptically shaped rocks.

10. The window well according to claim 7, wherein the pattern is a series of generally rectangular shaped rocks.

11. The window well according to claim 7, wherein the window well liner is secured to the window well with screws, which pass through the liner and into a proud section of the window well.

12. A method for lining a window well, comprising the steps of:
measuring the window well's dimensions, including the height and perimeter;
cutting a liner to match the window well's height and perimeter; and
securing the liner to the window well.

13. The method according to claim 12, wherein the liner is cut approximately three inches taller than the window well.

14. The method according to claim 12, wherein the liner is cut between one and three inches shorter than the perimeter of the window well depending on the pattern of the liner.

15. The method according to claim 14, wherein the liner is secured to the window well with screws, and further comprises the step of painting over the screws to match the color of the liner.

16. The method according to claim 12, further comprising the step of attaching a cap to both a top edge of the liner and a top edge of the window well.

17. The method according to claim 12, before the measuring step, the steps of:
coating a mold with a release agent;
coloring a pattern of the mold to give the pattern a natural look;
applying a product to the mold to form a liner;
removing the liner from the mold;
touching up imperfections in the liner, if necessary; and
coating the liner with a protective coating.

18. The method according to claim 17, wherein the pattern is colored with alkyd based paint.

19. The method of claim 17, wherein the product is chosen from one of a group consisting of polyurethane, plastic, rubber, fiberglass and carbon fiber.

20. The method according to claim 17, wherein the product comprises polyurethane.
